(19) United States
(12) Patent Application Publication
(10) Pub. No.: US 2008/0017797 A1
(43) Pub. Date: Jan. 24, 2008

(54) PATTERN INSPECTION AND MEASUREMENT APPARATUS

(76) Inventors: Zhaohui CHENG, Tokyo (JP); Hiroshi Makino, Kokubunji (JP); Kenji Tanimoto, Hitachinaka (JP); Seiko Omori, Kokubunji (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/779,140

(22) Filed: Jul. 17, 2007

(30) Foreign Application Priority Data
Jul. 21, 2006 (JP) 2006-199072

(51) Int. Cl. G01N 23/00

(52) U.S. Cl. 250/310

(57) ABSTRACT

Pattern inspection and measurement technique where the failure of the detection of a secondary signal due to the variation of an optical condition of a primary electron beam or the occurrence of an electric field perpendicular to a traveling direction of the primary electron beam in a surface of a wafer is minimized, an SEM image the SN ratio of which is high and which hardly has shading in a field of view can be acquired and measurement such as measuring the dimensions and configuration of a measured object and inspecting a defect is enabled at high precision and high repeatability. A lens for converging a secondary signal is installed in a position which a traveling direction of the primary electron beam crosses or on a course of the secondary signal spatially separated from the primary electron beam by Wien filter. An SEM image always free of shading caused by the failure of the detection of a secondary signal in the field of view can be acquired by providing a unit that changes the setting of the lens according to the optical condition such as retarding voltage and an electrification control electrode of the primary electron beam.

### CLAIM OF PRIORITY

The present application claims priority from Japanese application JP 2006-199072 filed on Jul. 21, 2006, the content of which is hereby incorporated by reference into this application.

### FIELD OF THE INVENTION

The present invention relates to the manufacturing technology of minute circuit patterns formed on a substrate for a semiconductor device and a liquid crystal display, particularly relates to the inspection and measurement technique of patterns for a semiconductor device and a photomask by an electron beam.

### BACKGROUND OF THE INVENTION

Currently, in the manufacturing line of a semiconductor device, technique for inspecting and measuring a state of circuit patterns formed on a wafer on the way of a process fills an important role.

This inspection and measurement technique has been mostly based upon an optical microscope, however, to cope with the recent miniaturization of a semiconductor device and the recent intricacy of a manufacturing process, an inspection and measurement apparatus based upon an electron microscope is being popularized. Particularly, in the management of dimensions of a semiconductor circuit pattern, a length measuring scanning electron microscope (SEM) based upon an electron microscope currently functions as quality management means essential for a manufacturing process. When the dimensions of a minute circuit pattern are managed, high plane resolution, high measurement precision and high repeatability are demanded and simultaneously, in measurement, it is also essential to inhibit damage to circuit patterns. To make these demands compatible, generally, a primary electron beam is accelerated with high energy and is decelerated by retarding voltage applied to a sample including semiconductor patterns to be measured immediately before the primary electron beam is incident on the sample. However, when an electro-optical condition also including varying the irradiated energy of the primary electron beam by adjusting retarding voltage if necessary is varied in the vicinity of the sample, the divergence of secondary signals emitted from a surface of a circuit pattern also varies, a detection rate of secondary signals varies, and an abstract contrast is caused in a secondary signal image. Hereby, the measurement precision and the repeatability of pattern dimensions may be deteriorated. Therefore, even if the irradiated energy of the primary electron beam is varied, it is important to maintain the divergence of the secondary signals and to detect the secondary signals at a uniform detection rate.

In the inspection of a semiconductor device, need for the inspection of the failure which cannot be detected by an optical inspection apparatus of an electric characteristic such as continuity and non-continuity increases and an inspection apparatus using an electron beam is being popularized. To detect the failure of an electric characteristic of a semiconductor device by the electron beam type inspection apparatus, a circuit pattern formed on a surface of a wafer is charged and is inspected using contrast manifest thereby. This method is called potential contrast and is effective so as to detect the failure of an electric characteristic of a semiconductor device. A principal plane of an objective has a tendency to approach a wafer to acquire high resolution, thereby, the divergence of secondary electrons is extended, and it is made difficult to detect all secondary signals by a detector. Besides, an optical condition of the primary electron beam may greatly fluctuate according to an object to be inspected, thereby, a problem that the divergence of secondary electrons is extended and a detection rate fluctuates occurs, and the problem has an effect on the sensitivity and the repeatability of inspection. The enhancement of controllability on a detection rate of secondary signals contributes to the enhancement of the detectable sensitivity and the repeatability of the failure of an electric characteristic.

For one example, inspection for a defect of a minute pattern on a wafer will be described below.

A semiconductor device is manufactured by repeating a process for transferring a pattern formed mainly in a photomask on a wafer by lithography and etching. In a semiconductor manufacturing apparatus, as whether various processing such as etching is satisfactory or not and the contamination of a foreign matter have a large effect upon a yield of a semiconductor device, a method of inspecting a pattern on a wafer in a manufacturing process for detecting abnormality and the occurrence of failure as early as possible has been executed.

When a pattern is inspected as described above, a defect is specified by acquiring an image of a pattern from a scanning electron microscope (SEM). According to the recent miniaturization of a pattern, the difficulty of working a contact hole increases, the number of defects of continuity caused inside the contact hole particularly increases, and high defect detection technique is required.

FIG. 6 schematically shows a principle for inspecting an object to be measured including a semiconductor pattern and its defective parts.

As shown in FIG. 6, a reference numeral 400 denotes a section of a wafer in which a part of the object to be measured where a semiconductor pattern is formed is enlarged, an SiO₂ film 405 is formed on an Si substrate 404, a contact hole is worked, and metal is buried. In this case, a reference numeral 401 denotes a normal part and 402 denotes a defect of continuity. To detect this defect, it is required to charge the wafer and to acquire a potential contrast image representing charged potential difference made because each electric resistance of the normal part and the defect is different as difference in the number of detected secondary electrons.

The potential contrast image is acquired by detecting a secondary electron or a reflected electron generated by radiating a primary electron beam. The primary electron beam 410 radiated from an electron source 10 is accelerated with high energy, is decelerated by retarding voltage 406 applied to the wafer immediately before the primary electron beam is incident on a sample, a secondary signal emitted from a surface of the pattern is made to collide with a reflector 17, and a second secondary signal generated hereby is detected by a detector 411. JP-A No. 2000-188310 discloses an example of the configuration of an electro-optical system that uses such a reflector method and detects a secondary electron. In an invention disclosed in JP-A No. 2000-188310, a potential contrast image is acquired by providing an ExB deflector on an optical axis of a primary electron beam, separating a generated secondary electron from the optical axis of the primary electron beam and leading it to a reflector and detecting a deputy-order particle generated by the secondary electron that collides with the reflector.

The potential contrast image has two types in one type of which a surface of a wafer is charged with positive charge and in the other type of which the surface of the wafer is charged with negative charge according to the structure of the wafer to be inspected and a condition of inspection. For example, a method of varying the incident energy of an electron beam can be given (for example, refer to p. 12 of SPIE 4344 in 2001 by H. Nishiyama, et al.). For another method, the potential of an electrification control electrode 407 installed opposite to a wafer is varied by an electrification control electrode 408 and even if the surface of the wafer is charged with positive charge or negative charge, the incident energy on the wafer of the used electron beam 410 is controlled so that the emission efficiency of a secondary electron emitted from the wafer is 1 or more (for example, 500 eV).

However, when the potential of the electrification control electrode 407 is varied, an orbit or the divergence 409 of the secondary electron varies. Thereby, a detection rate by the detector 411 of the secondary signals varies. In a method of detecting the secondary signal via the reflector 17, the divergence on the reflector of the secondary signals varies. Or in a method of directly detecting a secondary signal, as the divergence on a detecting element of the secondary signals varies, the failure of the detection of secondary electrons occurs, the uniformity in a field of view of an SEM image is deteriorated, and the sensitivity and the precision of inspection and analysis are deteriorated.

Next, the measurement of dimensions of the minute pattern on the wafer will be described as one example. As the pattern of the semiconductor device is miniaturized, the management of the dimensions and configuration of the circuit pattern on the wafer is required to be stricter. Deviation slightly off a designed value has a large effect on the performance of the semiconductor device.

A method of measuring the circuit pattern on the wafer has two types of an optical type and an electron beam type. For measurement in a hole and on a dimensional image, the electron beam type is mainly used. For example, a method of applying second acceleration voltage different from first voltage to the sample and observing an image after surface electrification desired in observation is applied to the insulated surface before the observation using the electron beam of the target to which the first voltage is applied is proposed (for example, refer to JP-A No. 2000-200579).

### SUMMARY OF THE INVENTION

According to the above-mentioned method, as secondary signals emitted from inspected material by the irradiation of the electron beam are detected in a divergent state by the detector, a detection rate of the secondary signals is low and the SN ratio of the SEM image is unsatisfactory. Therefore, to acquire one SEM image, the electron beam is radiated onto the same area by plural times, acquired secondary signals are equalized and an SEM image is output, however, much time is required to measure the dimensions of the pattern.

When local electrification occurs in the circuit pattern on the wafer because of some cause, a problem that an orbit of the secondary electron greatly fluctuates, abnormal shading occurs on the SEM image and the precision and the repeatability of measuring dimensions are greatly deteriorated is caused.

An object of the invention is to provide pattern inspection and measurement technique where the failure of the detection of a secondary signal due to the variation of an optical condition of a primary electron beam or the occurrence of an electric field perpendicular to a traveling direction of the primary electron beam in a surface of a sample is minimized, an SEM image the SN ratio of which is high and the shading in a field of view of which is small can be acquired and the measurement of dimensions and a configuration of the measured object and the inspection of a defect are enabled at high precision and at high repeatability.

To achieve the object, there is desired a lens that can ordinarily converge secondary signals emitted from a pattern on the sample in the same position or in the same range of a reflector for detecting a secondary signal independent of the variation of an electro-optical condition of a primary electron beam for inspection and measurement and the variation of the potential of an electrification control electrode installed opposite to the surface of the sample or independent of an electric field perpendicular to an incident direction of the primary electron beam in the surface of the sample.

The above-mentioned lens for converging a secondary electron can converge a secondary signal in a predetermined position even if the lens is installed in some position on an optical path on which the secondary signal generally passes. However, to inhibit a bad effect such as aberration outside a diameter and an optical axis of the primary electron beam on the performance of the primary electron beam, the lens is required to be arranged in a position which the primary electron beam crosses or in the vicinity of the cross position or the lens is required to be installed on a traveling path of the secondary signal after the secondary signal is spatially separated from the primary electron beam. To spatially separate the secondary signal from the primary electron beam, an ExB filter (Wien filer) is used for example.

As described above, as orbits including the divergence of secondary electrons vary according to the setting of the electrification control electrode, retarding voltage and others, it may safely be said that a function for changing a set condition of the lens that controls the orbit of the secondary signal according to set conditions of an electro-optical system, for example, voltage applied to the electrification control electrode and retarding voltage is essential.

That is, the secondary signal converging lens in the invention is installed in a position in which the lens crosses a traveling direction of the primary electron beam or on a course spatially separated from the primary electron beam of the secondary signal. As a measure to change the setting of the lens for converging a secondary signal according to an optical condition (for example, retarding voltage and the electrification control electrode) of the primary electron beam is taken, an SEM image where no shading caused by the failure of the detection of a secondary signal in a field of view occurs can be ordinarily acquired.

According to the invention, the failure of the detection of a secondary signal due to the variation of an optical condition of the primary electron beam or the occurrence of an electric field perpendicular to a traveling direction of the primary electron beam in the surface of the sample is minimized and an SEM image the SN ratio of which is high and the shading in a field of view of which is small can be acquired.

Therefore, sample inspection and measurement technique that enables measuring dimensions and a configuration and inspecting a defect at higher precision and higher repeatability, compared with the conventional type can be provided by applying the scanning electron microscope according to the invention to a semiconductor sample visual inspection scanning electron microscope (inspection SEM), a defect review scanning electron microscope (review SEM) or a circuit pattern length measuring machine (CD-SEM).

### BRIEF DESCRIPTION OF THE DRAWINGS

FIG. 1 illustrates the configuration of an inspection and measurement apparatus equivalent to a first embodiment of the invention;

FIG. 2 illustrates the selection of a secondary signal converging lens control signal depending upon a shading occurrence situation in an SEM image;

FIG. 3 illustrates the selection of the secondary signal converging lens control signal depending upon a primary electron beam radiation condition;

FIG. 4 shows results of simulation showing the divergence of secondary signals on a reflector and a detection rate, FIG. 4A shows a case that a lens is turned off, and FIG. 4B shows a case that the lens is turned on;

FIG. 5 shows a result of an experiment showing the reduction by the lens for converging a secondary signal of shading in a field of view, FIG. 5A shows a case that the lens is unoperated, and FIG. 5B shows a case that the lens is operated;

FIG. 6 illustrates a section of a wafer of a semiconductor device and a defect;

FIG. 7 illustrates the configuration of an inspection and measurement apparatus equivalent to a second embodiment of the invention;

FIG. 8 illustrates the configuration of an inspection and measurement apparatus equivalent to a third embodiment of the invention; and

FIG. 9 illustrates the configuration of an inspection and measurement apparatus equivalent to a fourth embodiment of the invention.

### DETAILED DESCRIPTION OF THE PREFERRED EMBODIMENTS

Referring to the drawings, embodiments of the invention will be described in detail below.

### First Embodiment

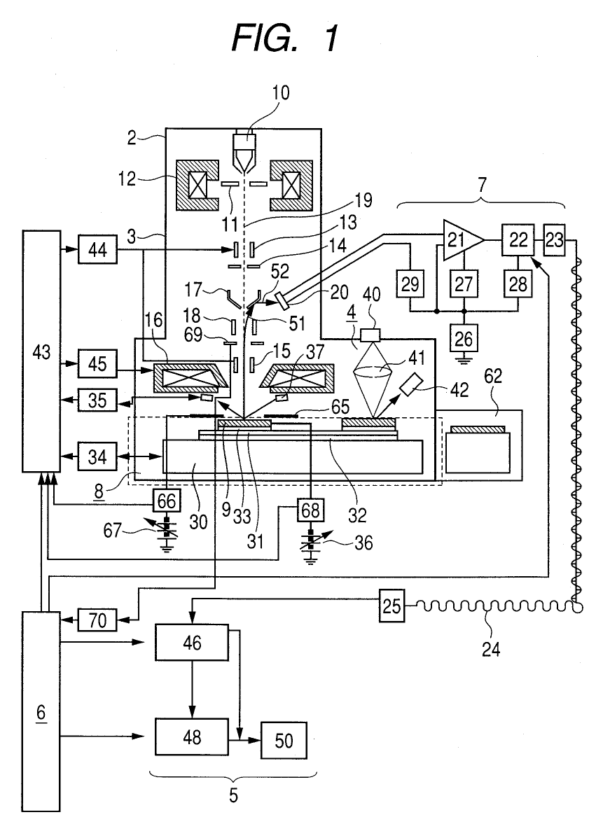

FIG. 1 shows the configuration of an inspection and measurement apparatus equivalent to a first embodiment. The inspection apparatus equivalent to this embodiment is a retardation type scanning electron microscope provided with a sample surface electrometer and an electrification control system and can be applied to inspection SEM, review SEM, measurement SEM and others.

The scanning electron microscope shown in FIG. 1 s provided with an evacuated chamber 2 and a preliminary chamber (not shown in this embodiment) for carrying a wafer 9 as a sample into the chamber 2 and the preliminary chamber is configured so that it can be evacuated independently from the chamber 2. The inspection apparatus includes a controller 6 and an image processor 5 in addition to the chamber 2 and the preliminary chamber. The chamber 2 roughly includes an electro-optical system 3, the electrification control system, a detecting system 7, a sample housing 8 and an optical microscope 4. In this embodiment, the chamber 2 means the whole vacuum container including the sample housing 8, and the electro-optical system 3, the electrification control system, the detecting system 7 and the optical microscope 4 are operated in a decompressed condition in the vacuum container. The sample housing 8 is a concept showing space in which a sample stage is driven in the chamber 2 and an area encircled by a dotted line in FIG. 1 is equivalent to the sample housing. For the inspected sample, a semiconductor wafer where a wiring pattern and a circuit pattern are formed, a sample piece extracted by dividing a part of the wafer or a semiconductor chip where a circuit is formed can be given, however, the potential of a sample except a semiconductor device such as a magnetic head, a record medium and a liquid crystal display panel can be also naturally inspected.

The electro-optical system 3 includes an electron source 10, an electron beam withdrawing electrode 11, a capacitor lens 12, a deflector for blanking 13, a scanning deflector 15, a diaphragm 14, an objective 16, a lens for converging a secondary signal 69, a reflector 17 and an ExB deflector 18. In the detecting system 7, a detector 20 is arranged on the upside of the objective 16 in the chamber 2. A signal output from the detector 20 is amplified in a preamplifier 21 installed outside the chamber 2 and is converted to digital data by an A/D converter 22. In the electro-optical system in this embodiment, the ExB deflector 18 makes the crossover of primary electron beams. Therefore, the lens for converging a secondary signal 69 is arranged between the ExB deflector 18 and the scanning deflector 15.

The electrification control system includes an electrification control electrode 65 arranged opposite to the stage, an electrification control electrode controller 66 and an electrification control power source 67.

The detecting system 7 includes the detector 20 in the evacuated chamber 2, the preamplifier 21, the A/D converter 22, an electric-to-optical converter 23, an optical fiber 24, a photoelectric converter 25, a high voltage power supply 26, a preamplifier driving power source 27, an A/D converter driving power source 28 and a reverse bias power source 29, which except the detector are located outside the chamber 2. The detector 20, the preamplifier 21, the A/D converter 22, the electric-to-optical converter 23, the preamplifier driving power source 27 and the A/D converter driving power source 28 are kept at positive potential by the high voltage power supply 26.

The sample housing 8 includes a sample stage 30, an X stage 31, a Y stage 32, a wafer holder 33, a length measuring machine for a position monitor 34 and an optical height gauge 35.

The optical microscope 4 is located in the vicinity of the electro-optical system 3 in the chamber 2, they are installed in positions apart by an extent in which they have no effect on each other, and distance between the electro-optical system 3 and the optical microscope 4 is already known. The X stage 31 or the Y stage 32 is reciprocated in the already known distance between electro-optical system 3 and the optical microscope 4. The optical microscope 4 is configured by a light source 40, an optical lens 41 and a CCD camera 42.

An instruction and a condition for operating each unit are output from the controller 6. The controller 6 is provided with a database in which control parameters of each unit, for example, the electro-optical system 3, the X stage 31, the Y stage 32 and others and their operational conditions are stored. The database is configured by hardware such as a nonvolatile storage that stores predetermined information, an arithmetic unit that processes the information stored in the storage and a memory that temporarily stores the information processed by the arithmetic unit. The storage in the database stores conditions such as acceleration voltage when an electron beam is generated, electron beam deflected width, deflection velocity, signal input timing to the detector, sample stage traveling speed and the setting of the lens for converging a secondary electron, the conditions are selected according to a purpose, and the control of each unit is executed. A user of the apparatus may also select the conditions for control stored in the database manually via a user interface, an operational condition is set in the controller 6 beforehand, and the apparatus may be also operated according to the setting.

The controller 6 monitors displacement in a position and height based upon signals from the length measuring machine for the position monitor 34 and the optical height gauge 35 using a correction control circuit 43, generates a correction signal based upon the result, and sends the correction signal to a lens power source 45 and a scanning signal generator 44 so that an electron beam always irradiates a right position.

To acquire an image of the wafer 9, an electron beam 19 converged to be thin is radiated onto the wafer 9, a secondary electron or a reflected electron or both 51 are generated, an image of the surface of the wafer 9 is acquired by detecting these in synchronization with the scanning of the electron beam 19, if necessary, the movement of the stages 31, 32.

For the electron source 10, a diffusive supply type thermal-field-emission electron source is used. As stable electron beam current can be secured by using the electron source 10, compared with a tungsten (W) filament electron source and a cold-emission electron source for example which are conventional types, a potential contrast image hardly varied in brightness is acquired. The electron beam 19 is withdrawn from the electron source 10 by applying voltage between the electron source 10 and the electron beam withdrawing electrode 11. The electron beam 19 is accelerated by applying high negative potential to the electron source 10.

Hereby, the electron beam 19 advances in a direction of the sample stage 30 with energy equivalent to the potential, is converged by the capacitor lens 12, is further converged to be thin by the objective 16, and irradiates the wafer 9 mounted on the X and Y stages 31, 32 on the sample stage 30. The scanning signal generator 44 that generates a scanning signal and a blanking signal is connected to the deflector for blanking 13, and each lens power source 45 is connected to the capacitor lens 12 and the objective 16. Negative voltage (retarding voltage) can be applied to the wafer 9 by a retarding power source 36. A primary electron beam is decelerated by adjusting the voltage of the retarding power source 36 and electron beam irradiation energy to the wafer can be adjusted to an optimum value without changing the potential of the electron source 10.

A secondary electron or a reflected electron or both 51 generated by radiating the electron beam 19 onto the wafer 9 are accelerated by negative voltage applied to the wafer 9. The lens for converging a secondary signal 69 is arranged in a position which the primary electron beam crosses or in a position close to the cross position on the upside of the wafer 9 and hereby, the divergence of the secondary electrons or the reflected electrons or both 51 respectively accelerated is adjusted by the lens 69. For the lens for converging a secondary signal, either of a magnetic field type lens or an electrostatic type lens can be used. The magnetic field type lens and the electrostatic type lens may be also combined.

A controller 70 that controls the lens for converging a secondary signal 69 can vary in interlock with negative voltage applied to the sample and optical conditions of a primary electron beam including a set condition of the electrification control electrode 65. Besides, the ExB deflector 18 is arranged and a secondary electron or a reflected electron or both 51 respectively accelerated are deflected in a predetermined direction. An amount of deflection can be adjusted by the intensity of voltage and a magnetic field applied to the ExB deflector (Wien filter) 18. This electromagnetic field can be varied in interlock with negative voltage applied to the sample. The divergence and a traveling direction of secondary electrons or reflected electrons or both 51 are adjusted by the lens 69 and the ExB deflector 18, and the electron or both collide with the reflector 17 on a predetermined condition. When the secondary electron or the reflected electron or both 51 respectively accelerated collide with the reflector 17, a second secondary electron or a second reflected electron or both 52 are generated from the reflector 17.

The second secondary electron and a back scattered electron 52 respectively generated by the collision with the reflector 17 are led to the detector 20 by an attractive electric field. The detector 20 detects the second secondary electron or the second reflected electron or both 52 generated when the secondary electron or the reflected electron or both 51 generated while the electron beam 19 irradiates the wafer 9 are accelerated afterward and collide with the reflector 17 at the scanning timing of the electron beam 19. A signal output from the detector 20 is amplified by the preamplifier 21 installed outside the chamber 2 and is converted to digital data by the A/D converter 22. The A/D converter 22 converts the analog signal detected by the detector 20 to a digital signal immediately after the analog signal is amplified by the preamplifier 21 and transmits it to the image processor 5. As the converter digitizes the detected analog signal immediately after the detection and transmits it, a high-speed and high-SN ratio signal can be acquired. For the detector 20, a semiconductor detector may be also used.

The wafer 9 is mounted on the upside of the X and Y stages 31, 32 and in inspection, either of a method of making the X and Y stages 31, 32 at a standstill and dimensionally scanning the electron beam 19 or a method of continuously moving the Y and Y stages 31, 32 in a Y (longitudinal) direction at fixed speed in inspection and scanning the electron beam 19 straight in an X (lateral) direction can be selected. When a certain specific relatively small area is inspected, the former method of making the stages at a standstill and inspecting is effective and when a relatively large area is inspected, the latter method of continuously moving the stages at fixed speed and inspecting is effective. When the electron beam 19 is required to be blanked, the electron beam 19 is deflected by the deflector for blanking 13 and can be controlled so that the electron beam does not pass the diaphragm 14.

For the length measuring machine for the position monitor 34, a length measuring meter depending upon laser interference is used in this embodiment. Positions of the X stage 31 and the Y stage 32 can be monitored at real time and are transferred to the controller 6. Besides, the data of the number of revolutions of each motor of the X stage 31, the Y stage 32 and the wafer holder 33 is also similarly transferred to the controller 6 from each driver, the controller 6 can precisely grasp an area and a position irradiated by the electron beam 19 based upon these data, and if necessary, the displacement of the position irradiated by the electron beam 19 is corrected by the correction control circuit 43 at real time. The area irradiated by the electron beam can be stored every wafer.

For the optical height gauge 35, optical measurement equipment according to a method of measuring except an electron beam, for example laser interference measurement equipment and reflected light type measurement equipment that measures variation depending upon a position of reflected light are used to enable measuring the height of the wafer 9 mounted on the upside of the X and Y stages 31, 32 at real time. In this embodiment, a method of irradiating the wafer 9 by white light radiated from a light source 37, instructing the position detection monitor to detect a position of its reflected light and calculating an amount of the variation of the height based upon the variation of the position is used. The focal distance of the objective 16 for converging the electron beam 19 is dynamically corrected based upon data measured by the optical height gauge 35 so that the electron beam 19 always focused on an inspected area can be radiated. Besides, the warpage of the wafer 9 and the asymmetry of the height are measured before the electron beam is radiated and a condition for correction every inspection area of the objective 16 may be also set based upon the data.

The image processor 5 includes an image storage 46, an information processor 46 and a monitor 50. The information processor 48 is provided with a memory storing software that acquires the dimensional distribution information of a secondary signal emitted from an arbitrary area on the inspected sample from a signal output from the detecting system 7 and calculates potential charged on the surface of the inspected sample based upon the dimensional distribution information and software that processes the dimensional distribution information and inspects a defect of the inspected sample, and processing for detecting charged potential and inspecting a defect is executed. For the dimensional distribution information, image data in desired power or pixel data of the corresponding image can be used. For the size of a picture element and the size of a field of view of image data, data in arbitrary size can be used. Though the following is not shown, an information input unit for an apparatus user to set and input required information to a control system of the apparatus is provided to the monitor 50, and the monitor 50 and the information input unit configure a user interface of the apparatus. A picture signal of the wafer 9 detected by the detector 20 is amplified in the preamplifier 21, is converted to an optical signal in the electric-to-optical converter 23 after the picture signal is digitized in the A/D converter 22, is transmitted via the optical fiber 24, and is stored in the image storage 46 after the picture signal is converted to an electric signal in the photoelectric converter 25 again. A condition on which the electron beam irradiates and various detection conditions of the detecting system in image formation are set in setting detection conditions beforehand, are filed, and are registered in a database in the controller 6.

Next, operation executed by the controller 6 for controlling the lens for converging a secondary signal 69 will be described in detail. First, suppose that shading occurs in an image sensed on a certain electro-optical condition. An arithmetic unit in the information processor 48 analyzes the signal strength of picture elements in a shading area in the image and estimates an extent of the shading. For example, when a value of the signal strength of picture elements in the whole specific area on an image in a certain field of view is larger than a predetermined threshold, it is judged that shading occurs. The arithmetic unit estimates an extent of caused shading based upon information such as a rate for which a shading caused area accounts in the field of view and a maximum value of the signal strength of the picture elements in the shading caused area and transmits the information of the extent of the shading to the controller 6.

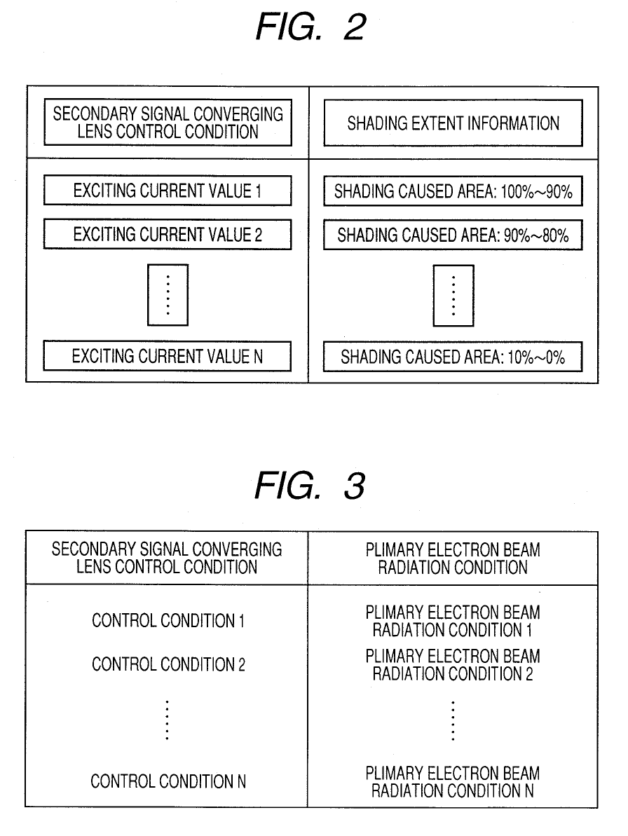

In the meantime, a storage in the controller 6 stores a correction table correlating the information of an extent of shading and a control condition of the lens for converging a secondary signal 69. For the information of an extent of shading stored in the correction table, maximum picture element signal strength in a shading area, the area of the shading caused area, and a rate for which the shading caused area accounts in a sensed field image (for example, the ratio of the number of all picture elements in a field image of predetermined size in predetermined power and the number of picture elements in the shading caused area in the corresponding field image) can be given. For the condition for controlling the lens for converging a secondary signal 69, a value of voltage applied to an electrode can be given when the lens 69 is an electrostatic lens and a value of current for exciting a coil can be given when the lens is an electromagnetic lens. FIG. 2 conceptually shows one example. FIG. 2 shows an example of the configuration of a correction table when a current value for exciting an electromagnetic lens is adopted for the condition for controlling the lens for converging a secondary signal 69 and when a rate of a shading caused area is adopted for the information of the extent of shading. The arithmetic unit in the controller 6 retrieves the correction table based upon the information of the extent of shading transmitted from the information processor 48, selects a suitable condition for controlling the lens for converging a secondary signal 69, and transmits the selected condition to the secondary signal converging lens controller 70. The secondary signal converging lens controller 70 applies suitable exciting current to the lens for converging a secondary signal 69 based upon the transmitted control information.

To use the correction table shown in FIG. 2, information of the extent of shading is required and therefore, a judgment image for judging whether shading occurs on the currently set electro-optical condition or not is required to be acquired. Actually, when an image for adjustment is acquired in adjusting the electro-optical system for inspection and measurement or when shading occurs on the way of inspection and measurement, the correction table is properly read and a correction signal is transmitted to the secondary signal converging lens controller 70.

For example, suppose that shading occurs in an image for adjustment acquired when the electro-optical system is set. Such an image for adjustment can be acquired when the primary electron beam is focused for example. When the controller 6 detects the occurrence of shading, it transmits a signal telling the occurrence of shading to the information processor 48 and the information processor 48 instructs the monitor 50 to display a request for determining whether the shading is required to be eliminated or not. The request for determining is made by instructing the monitor to display a button and an icon including “ELIMINATE SHADING” and “RESET ELECTRO-OPTICAL SYSTEM” for example via GUI and requesting the user of the apparatus to select the button or the icon. The selection may be also made via an information input unit. Simultaneously, a button or an icon including “UNNECESSARY TO ELIMINATE SHADING” and “UNNECESSARY TO RESET ELECTRO-OPTICAL SYSTEM” for example for confirming the user's will that the elimination or resetting is unnecessary is also displayed via GUI. When the user of the apparatus presses the button that the elimination or resetting is necessary, the information processor 48 transmits information that the button is pressed to the controller 6. When the controller 6 receives the information that the elimination of shading is necessary from the information processor 48, the controller selects a control condition most suitable for eliminating shading of the lens for converging a secondary signal 69 referring to the correction table and transmits the control condition to the secondary signal converging lens controller 70. Hereby, the automatic control of the lens for converging a secondary signal is realized.

In the above-mentioned description, conditions for selecting the control condition of the lens for converging a secondary signal are required to be included in the correction table, however, a correction table storing only conditions for adjusting the lens for converging a secondary signal 69 and the electro-optical system may be also used. In that case, when shading occurs, plural conditions for resetting the electro-optical system such as “MEASURE 1 FOR SHADING”, “MEASURE 2 FOR SHADING”, - - - , “MEASURE N FOR SHADING” are displayed on the monitor 50. The user of the apparatus selects a condition considered most suitable for correcting shading, for example, “MEASURE 2 FOR SHADING” referring to an image on which shading occurs. The information processor 48 transmits information that the user of the apparatus selects the measure 2 for shading to the controller 6, the controller 6 selects an operating condition of the lens for converging a secondary signal corresponding to the measure 2 for shading referring to the correction table, and transmits the selected operating condition to the secondary signal converging lens controller 70. The above-mentioned control method is semiautomatic control and is not complete automatic control; however, even if causality between the information of the extent of shading and the condition for setting the electro-optical system is not definite, the above-mentioned control method has an advantage that the operation of the apparatus can be automized to some extent. Besides, as much data is not required to be stored in the correction table, the above-mentioned control method also has an advantage that a memory of small capacity can be used.

FIG. 3 shows an example of another configuration of the correction table. There is a case that conditions for radiating the primary electron beam on which shading often occurs depending upon a type of an inspected sample are known beforehand and in such a case, a correction table storing the conditions for radiating the primary electron beam (for example, voltage withdrawn from the electron source, a beam current value, a retarding voltage value, a value of voltage applied to the electrification control electrode and a control condition of the ExB deflector) and the control condition of the lens for converging a secondary signal 69 with the conditions correlated is used. For example, in a field “SECONDARY SIGNAL CONVERGING LENS CONTROL CONDITION” of the correction table shown in FIG. 3, a value of voltage applied to the electrode, a current value for exciting a coil or their combination are stored. In a field “PRIMARY ELECTRON BEAM RADIATION CONDITION”, any of voltage withdrawn from the electron source, a beam current value, a retarding voltage value, a value of voltage applied to the electrification control electrode and a control condition of the ExB deflector or their combination are stored. An optimum control condition of the lens for converging a secondary signal can be selected when a condition for radiating the primary electron beam is set by using the correction table shown in FIG. 3.

The example that control parameters of the lens for converging a secondary signal 69 are stored in a table format has been described, however, the control parameters and conditions for selecting the corresponding control parameter are not necessarily required to be stored in the table format. The conditions for selecting the corresponding control parameter can be made intricate to an arbitrary extent by combining various parameters.

The example that the image processor 5 and the controller 6 are separate has been described; however, the image processor 5 and the controller 6 may be also configured by the same information processor.

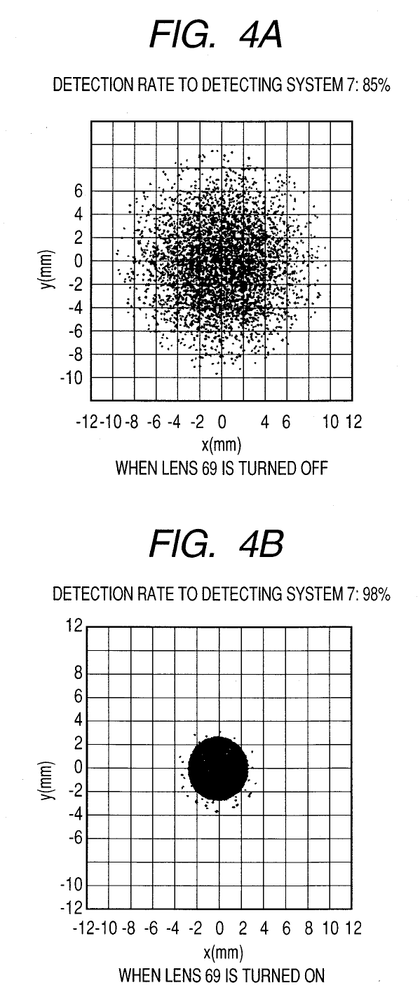

Next, one example of a result of calculating the divergence of secondary electrons emitted from the wafer on the reflector 17 in the configuration of the apparatus in this embodiment when the lens for converging a secondary signal 69 is unoperated (FIG. 4A) and when the lens is operated (FIG. 4B) is shown in FIGS. 4A and 4B. The divergence of secondary electrons shown in FIG. 4 is the divergence on the reflector 17 of secondary electrons emitted from the wafer 9 when the primary electron beam having certain irradiation energy (E_{Land}) irradiates one spot of the surface of the wafer 9 on a certain electro-optical condition and is a result of simulating a detection rate to the detecting system 7. Though the following is not shown in FIG. 4, a secondary signal also scans the reflector 17 accordingly when the primary electron beam scans the surface of the wafer 9 (as shown in FIG. 4A, the whole divergent secondary signals scan the reflector). According to a result of this simulation, when a scanned range on the reflector is large, the dependency upon an outgoing position on the reflector of a detection rate proportional to the strength of the secondary signal 51 to the detector 20 of a second secondary electron or a reflected electron or both 52 is remarkable and shading occurs on a secondary signal image. When an electric field component perpendicular to the incident primary electron beam exists in the vicinity of a boundary of patterns different in an electric characteristic on the wafer, a position in which the secondary signal hits the reflector 17 is further off the center. Therefore, shading occurs on a secondary signal image because of the similar reason.

In the meantime, as shown in FIG. 4B, when the lens for converging a secondary signal 69 is operated, the divergence of secondary signals can be controlled in a predetermined divergent range and in addition, a shift amount on the reflector of the primary electron beam can be minimized. Hereby, an SEM image where no shading caused by the failure of the detection of a secondary signal in a field of view occurs can be acquired.

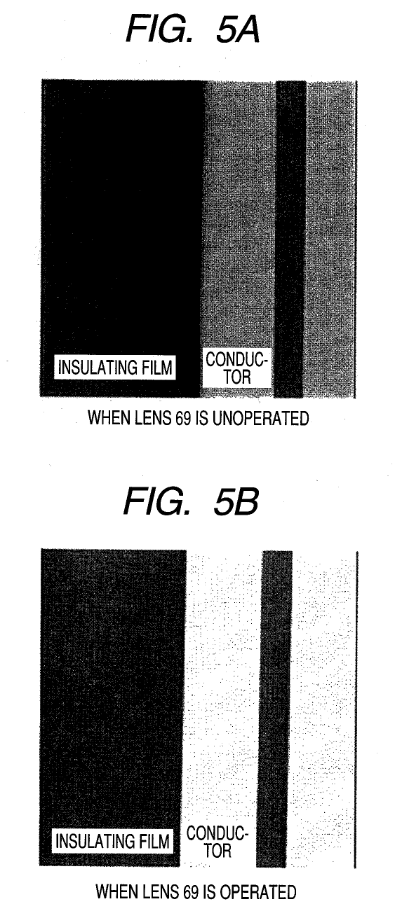

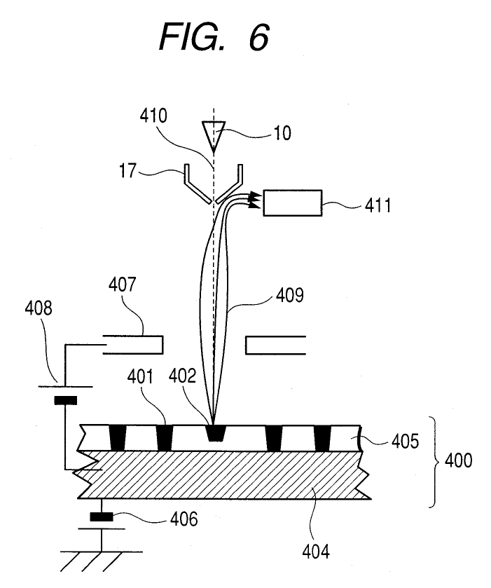

FIG. 5A shows an SEM image of a boundary of a conductor and an insulator on the wafer. When the lens for converging a secondary signal 69 is operated, shading in the field of view in the SEM image can be prevented as shown in FIG. 4B showing the result of the simulation. It proves that the mean brightness of an image is also greatly enhanced when the lens 69 is operated.

As described above, in the apparatus equivalent to this embodiment, a detection rate of secondary signals emitted from a wafer pattern can be greatly enhanced by providing the lens for converging a secondary signal and a uniform SEM image hardly having shading in the field of view can be acquired. This contributes to the enhancement of the SN ratio of the image and contributes to the enhancement of the sensitivity of inspection and higher precision and higher repeatability of measurement.

### Second Embodiment

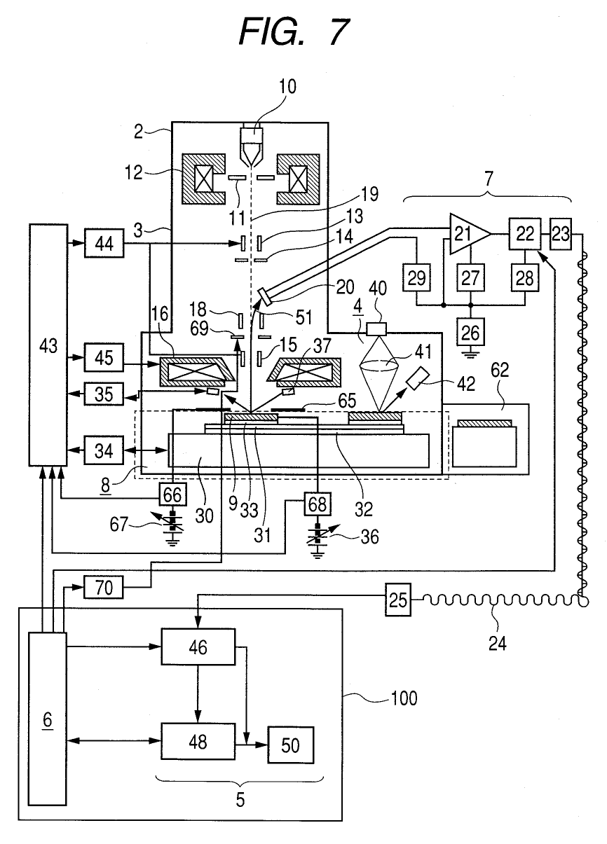

There is also a method of instructing a detector 20 to directly detect a secondary signal 51 accelerated from a wafer without using a reflector 17 and instructing a detecting system 7 to image. In this embodiment, the configuration of an apparatus and a setting method when the detector 20 is arranged outside an optical axis of a primary electron beam in such a method of directly detecting the secondary signal will be described. In this embodiment, the same reference numeral is allocated to a unit and others provided with the same function as those in the first embodiment and the description is omitted. In the configuration of the apparatus shown in FIG. 7, an image processor 5 and a controller 6 are included in the same information processor 100.

FIG. 7 shows the configuration of the inspection and measurement apparatus equivalent to a second embodiment. A secondary electron or a reflected electron or both 51 generated by radiating an electrode beam 19 onto a wafer 9 are accelerated by negative voltage applied to the wafer 9. A lens for converging a secondary signal 69 is arranged on the upside of the wafer 9 and hereby, the divergence of the secondary electrons or the reflected electrons or both 51 respectively accelerated is adjusted by the lens 69. A controller 70 that controls the lens 69 can vary in interlock with negative voltage applied to a sample and optical conditions of the primary electron beam including a set condition of an electrification control electrode 65. Besides, an ExB deflector 18 is arranged and a secondary electron or a reflected electron or both 51 respectively accelerated are deflected in a predetermined direction. An amount of deflection can be adjusted by the intensity of voltage applied to the ExB deflector 18 and a magnetic field. This electromagnetic field can be varied in interlock with negative voltage applied to the wafer.

The divergence and a traveling direction of the secondary electrons or the reflected electrons or both 51 are adjusted by the lens 69 and the ExB deflector 18, and the electron or both are led to the detector 20 by an attractive electric field generated from the detector 20. The detector 20 detects a secondary electron or a reflected electron or both 51 generated while the electron beam 19 irradiates the wafer 9 at the scanning timing of the electron beam 19. In this embodiment, operating conditions of the ExB deflector 18 and the lens for converging a secondary signal 69 are required to be controlled together. Therefore, in a correction table stored in the information processor 100, the operating condition (a value of current for exciting a coil and a value of voltage applied to an electrode) of the ExB deflector 18 is stored in addition to the operating condition of the lens for converging a secondary signal 69.

As described above, the secondary electron or the reflected electron or both 51 can be detected substantially without loss in a state in which they directly hit the detector 20 by optimizing the settings of the ExB deflector 18 and the lens for converging a secondary signal 69 according to the optical conditions of the primary electron beam, and an SEM image the SN ratio of which is high and which hardly has shading caused by the failure of the detection of the secondary signal in a field of view can be acquired.

### Third Embodiment

There is also a method of installing a detector 20 on a course (an optical axis) of a primary electron beam (a method of directly detecting a secondary signal). In this embodiment, the configuration of an apparatus and a setting method in that case will be described. In this embodiment, the same reference numeral is allocated to a unit and others provided with the same function as that in the first embodiment and the description is omitted.

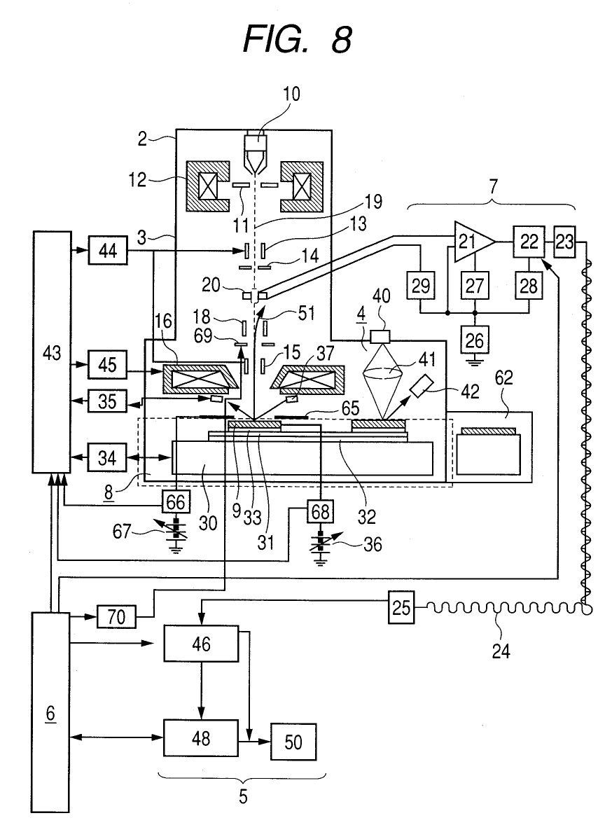

FIG. 8 shows the configuration of an inspection and measurement apparatus equivalent to a third embodiment. A secondary electron or a reflected electron or both 51 generated by radiating an electron beam 19 onto a wafer 9 are accelerated by negative voltage applied to the wafer 9. A secondary signal converging lens 69 is arranged on the upside of the wafer 9 and hereby, the divergence of the secondary electrons or the reflected electrons or both 51 respectively accelerated is adjusted by the lens 69. A controller 70 that controls the lens 69 can vary in interlock with negative voltage applied to a sample and optical conditions of the primary electron beam including a set condition of an electrification control electrode 65.

When the detector 20 is arranged on an optical axis, a course of the secondary electron or the reflected electron or both 51 is required to be devised so that they does not pass a hole so as to secure a detection rate of the electron or both because the detector has the hole to pass the primary electron beam. For example, the divergence of the secondary electrons or the reflected electrons or both 51 is first extended by the lens 69, secondary signals 51 that pass the hole to pass the primary electron beam are reduced, and the secondary electron or the reflected electron or both are led to the detector 20 by an attractive electric field generated from the detector 20. The detector 20 detects the secondary electron or the reflected electron or both 51 generated while the electron beam 19 irradiates the wafer 9 at the scanning timing of the electron beam 19.

As described above, the secondary electron or the reflected electron or both 51 can be detected substantially without loss so that they directly hit the detector 20 by optimizing the setting of the secondary signal converging lens 69 according to optical conditions of the primary electron beam and an SEM image the SN ratio of which is high and which hardly has shading caused by the expected defeat of the detection of a secondary signal in a field of view can be acquired.

### Fourth Embodiment

There is also a method of adjusting and detecting the divergence of secondary signals 51 accelerated from a wafer by a lens for converging a secondary signal 69 after the secondary signal is separated from the primary electron beam by an ExB deflector (Wien filter) 18. In this embodiment, the configuration of an apparatus and a setting method in that case will be described.

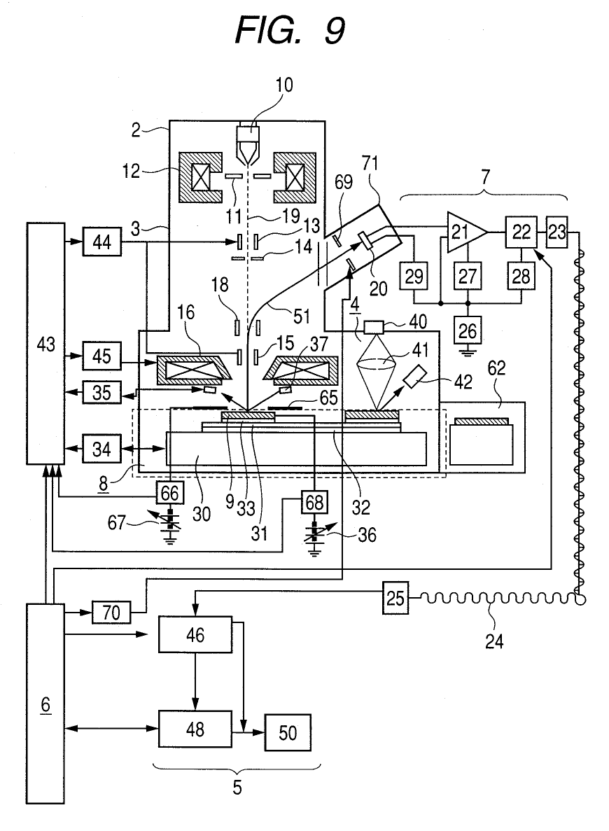

FIG. 9 shows the configuration of an inspection and measurement apparatus equivalent to a fourth embodiment. A secondary electron or a reflected electron or both 51 generated by radiating an electron beam 19 onto the wafer 9 are accelerated by negative voltage applied to the wafer 9. The electron or both are separated from the primary electron beam by the ExB deflector 18 installed on the upside of the wafer 9 and the secondary signal 51 is led to a detecting column 71. An electromagnetic field of the ExB deflector 18 can be varied in interlock with negative voltage applied to a sample and the accelerated secondary signal 51 is deflected in a predetermined direction. The lens for converging a secondary signal 69 is installed in a traveling direction of the secondary signal 51 in the detecting column 71. The diversion on the detector 20 of the secondary signals 51 is adjusted and the secondary signals are detected by the detector 20. The detector 20 detects a secondary electron or a reflected electron or both 51 generated while the electron beam 19 irradiates the wafer 9 at the scanning timing of the electron beam 19. The secondary signal 51 can be detected substantially without loss so that it directly hits the detector 20 by optimizing the settings of the ExB deflector 18 and the lens for converging a secondary signal 69 according to optical conditions of the primary electron beam and an SEM image the SN ratio of which is high and which hardly has shading in a field of view can be acquired.

As described in detail above, according to the invention, the failure of the detection of the secondary signal due to the variation of optical conditions of the primary electron beam or the occurrence of an electric field perpendicular to a traveling direction of the primary electron beam in a surface of the sample is minimized, an SEM image the SN ratio of which is high and which hardly has shading in the field of view can be acquired, measurement such as the measurement of dimensions and a configuration of a measured object, the inspection of a defect and review at high precision and at high repeatability is enabled, and the information closer to a truth of a semiconductor device can be acquired.

Besides, the measurement precision and the repeatability of the inspection and measurement apparatus can be enhanced by applying the secondary signal control lens according to the invention to an inspection and measurement apparatus using a charged particle. When the secondary signal control lens according to the invention is applied to a semiconductor inspection apparatus using a charged particle, the failure of an electric characteristic can be detected at high sensitivity.

What is claimed is:

1. A sample inspection and measurement apparatus, comprising:
an electron source;
an electro-optical system that scans a pattern on a surface of a sample by a primary electron beam emitted from the electron source;
a detector that detects a secondary signal secondarily generated from the surface of the sample by the irradiation of the primary electron beam; and
a device that measures dimensions of the pattern on the surface of the sample and inspects based upon dimensional distribution information of the detected secondary signals,
the electro-optical system having a lens for converging a secondary signal arranged in a position which the primary electron beam passes, in the vicinity of the position or on an orbit of a secondary electron separated from the primary electron beam, and
the lens for converging a secondary signal controlling the orbit of the secondary signal or the divergence of secondary signals.

2. The sample inspection and measurement apparatus according to claim 1,
wherein the electro-optical system has a Wien filter, and
wherein the lens for converging a secondary signal is arranged in a crossover made by the Wien filter.

3. The sample inspection and measurement apparatus according to claim 1,
wherein the electro-optical system has a Wien filer and an objective, and
wherein the lens for converging a secondary signal is arranged between the Wien filer and the objective.

4. The sample inspection and measurement apparatus according to claim 1,
wherein the lens for converging a secondary signal can adjust according to an optical condition of the primary electron beam and can arbitrarily control the divergence of the secondary signals.

5. The sample inspection and measurement apparatus according to claim 1,
wherein either of an electromagnetic lens or an electrostatic lens or the combination of the electromagnetic lens and the electrostatic lens is used as the lens for converging a secondary signal.

6. The sample inspection and measurement apparatus according to claim 1,
wherein the electro-optical system has a Wien filter, and
wherein the lens for converging a secondary signal is arranged between the Wien filter and the detector.

7. The sample inspection and measurement apparatus according to claim 5,
wherein a function for controlling the divergence of the secondary signals is realized by adjusting current for exciting a coil that generates a magnetic field of the electromagnetic lens or voltage applied to an electrode of the electrostatic lens.

8. The sample inspection and measurement apparatus according to claim 7, comprising:
a power source that supplies the exciting current or the applied voltage; and
a controller that controls the operation of the power source,
the controller including:
a storage that stores operating conditions of the lens for converging a secondary signal and a condition for selecting the operating conditions with them correlated; and
an arithmetic unit that reads information stored in the storage and transmits it to the power source.

9. The sample inspection and measurement apparatus according to claim 7,
wherein the divergence of the secondary signals is converged in a certain position on the reflector or on a detecting element of the detector or in a fixed range by the lens for converging a secondary signal according to an optical condition of the primary electron beam.

10. The sample inspection and measurement apparatus according to claim 8,
wherein the storage stores a correction table in which a value of exciting current supplied to the lens for converging a secondary signal or a value of voltage applied to the lens and a condition for radiating the primary electron beam are stored with them correlated.

11. The sample inspection and measurement apparatus according to claim 8,
wherein the device for measuring dimensions and inspecting has an image processor that analyzes the extent information of shading caused in an acquired image by applying predetermined processing to picture elements configuring the image generated based upon the secondary signals as the dimensional distribution information,
wherein the storage of the controller stores the correction table in which operating conditions of the lens for converging a secondary signal, a condition for selecting the exciting current value or the applied voltage value and the extent information of shading caused in the acquired secondary signal image are stored with them correlated, and
wherein the arithmetic unit of the controller selects the operating conditions of the lens for converging a secondary signal based upon the extent information of shading transmitted from the image processor.

12. The sample inspection and measurement apparatus according to claim 8, comprising:
the device that measures dimensions and inspects or a display screen that displays a result of operation by the controller; and
an information input unit for inputting information in response to a request for a response displayed on the display screen,
wherein, on the display screen, a plurality of primary electron beam radiation conditions and a request for persuading to select any of the conditions are displayed, and an operating condition of the lens for converging a secondary signal is determined according to the primary electron beam radiation condition selected via the information input unit.

13. The sample inspection and measurement apparatus according to claim 1, comprising:
a display screen that displays a result of operation in the device that measures dimensions and inspects; and
an information input unit for inputting information in response to a request for a response displayed on the display screen,
wherein the device that measures dimensions and inspects has an image processor that analyzes the extent information of shading caused in an acquired image by applying predetermined processing to picture elements configuring the image generated based upon the secondary signals as the dimensional distribution information, and
wherein, on the display screen, a plurality of buttons for resetting the electro-optical system to eliminate the shading are displayed, and an operating condition corresponding to the selected button and according to the electro-optical system of the lens for converging a secondary signal is determined.

14. The sample inspection and measurement apparatus according to claim 1,
wherein the electro-optical system has a reflector that reflects the secondary signal.

15. The sample inspection and measurement apparatus according to claim 1,
wherein the detector includes a detector that directly detects a secondary signal secondarily generated from the surface of the sample by the irradiation of the primary electron beam, and the detector is installed along a traveling course of the primary electron beam.
